(19) United States
(12) Patent Application Publication
(10) Pub. No.: US 2007/0261667 A1
(43) Pub. Date: Nov. 15, 2007

(54) Spark ignition internal combustion engine with direct fuel injection

(76) Inventors: Frank Altenschmidt, Biberach (DE); Dietmar Bertsch, Aspach (DE); Michael Dohn, Vaihingen (DE); Uwe Schaupp, Wernau (DE); Dirk Voigtlander, Korntal-Munchingen (DE)

Correspondence Address: KLAUS J. BACH, 4407 TWIN OAKS DRIVE, MURRYSVILLE, PA, 15668, US

(21) Appl. No.: 11/800,008

(22) Filed: May 1, 2007

Related U.S. Application Data
(63) Continuation-in-part of application No. PCT/EP05/11273, filed on Oct. 20, 2005.

(30) Foreign Application Priority Data
Nov. 3, 2004 (DE) 10 2004 053 046.7

(51) Int. Cl. F02B 3/00; F02B 5/00

(52) U.S. Cl. 123/298; 123/305

(57) ABSTRACT

In an internal combustion engine having at least one cylinder in which a combustion chamber is delimited between a piston and a cylinder head which includes at least one intake duct, at least one exhaust duct, a fuel injector arranged in the cylinder head and having outwardly opening injection nozzle through which fuel is injected into the combustion chamber in the form of a hollow cone, and a spark plug arranged in the combustion chamber (4) in such that the electrodes of the spark plug (7) are situated outside the injected hollow fuel cone formed during fuel injection, the fuel injector is positioned in the cylinder head in such a way that a first spacing (E) is provided between a fuel outlet opening and an intake passage axis, and the cylinder bore having a diameter (D), wherein a first ratio (E/D) is provided in a range from 0.15 to 0.22.

This is a Continuation-In-Part Application of pending International Patent Application PCT/EP2005/011273 filed Oct. 20, 2005 and claiming the priority of German Patent Application 10 2004 053 046.7 filed Nov. 3, 2004.

### BACKGROUND OF THE INVENTION

The invention relates to a spark-ignition internal combustion engine with direct fuel injection including a cylinder with a cylinder head and a piston disposed in the cylinder and forming between the piston and the cylinder head a combustion chamber with gas inlet and outlet passages and a fuel injector and spark plug mounted in the cylinder head.

During operation of spark-ignition internal combustion engines with direct fuel injection, injection nozzles are used which, by forming a defined fuel jet shape, aim to ensure improved combustion with low emission formation. In a jet-controlled combustion method in particular, outwardly-opening injection nozzles are used for configuring an optimized fuel injection.

DE 199 11 023 C2 discloses an internal combustion engine in which fuel is introduced into the combustion chamber in the form of a hollow cone through an outwardly-opening injection nozzle. Here, in a stratified-charge mode, the fuel impinges on compressed combustion air in the combustion chamber, so that a boundary vortex is formed in the combustion chamber. An ignitable air/fuel mixture is thereby transported into the vicinity of a spark plug. The spark plug is arranged in such a way that the electrodes of the spark plug project into the boundary vortex, with said electrodes being situated outside an envelope of the hollow fuel cone during the fuel injection.

Here, the arrangement of the injection nozzle in the combustion chamber and the positioning of a spark plug which is provided for igniting an air/fuel mixture which is formed determine the combustion properties of the internal combustion engine and its efficiency. In order to obtain reliable ignition, the configuration of the combustion chamber is important for avoiding misfires during operation. Such ignition misfiring is often to be attributed to the fact that, in the production of the injection nozzles, despite the adherence to permissible tolerances, fuel jet patterns are generated with slight deviations from an ideal jet structure.

It is the principal object of the present invention to provide a spark-ignition internal combustion engine with direct fuel injection, in which the mixture formation and the combustion in the combustion chamber are improved.

### SUMMARY OF THE INVENTION

In an internal combustion engine having at least one cylinder in which a combustion chamber is delimited between a piston and a cylinder head which includes at least one intake duct, at least one exhaust duct, a fuel injector arranged in the cylinder head and having outwardly opening injection nozzle through which fuel is injected into the combustion chamber in the form of a hollow cone, and a spark plug arranged in the combustion chamber (4) in such that the electrodes of the spark plug (7) are situated outside the injected hollow fuel cone formed during fuel injection, the fuel injector is positioned in the cylinder head in such a way that a first spacing (E) is provided between a fuel outlet opening and an intake passage axis, and the cylinder bore having a diameter (D), wherein a first ratio (E/D) is provided in a range from 0.15 to 0.22.

With the present invention, the formation of an ignitable mixture in the vicinity of the electrodes of the spark plug is optimized with regard in particular to a jet-controlled combustion method. The effects surprisingly obtained in this way are attributed to the favorable trade-off between a boundary vortex formed in the combustion chamber in relation to the bore diameter. The proposed first ratio causes within the vortex formed a remarkably fast fuel distribution, which is timed to a charge movement and cylinder bore diameter. In the outer regions of the boundary vortex, the fuel is thereby mixed rapidly with the combustion air.

The internal combustion engine according to the invention is additionally distinguished according to a second exemplary embodiment in that a second ratio of second spacing to bore diameter is provided in a range between 0.16 and 0.24, preferably between 0.18 and 0.22. In the proposed range, according to the invention, flow conditions are formed which are adapted to the bore diameter and, in the boundary vortex region, permit a fast and satisfactory mixture of the fuel droplets with the combustion air.

In a refinement of the invention, the spark plug and the fuel injector are positioned in such a way that a third spacing is generated between an injector axis and a free end section of the spark plug central electrode, wherein a third ratio of third spacing to bore diameter is provided in a range from 0.1 to 0.19, in particular from 0.13 to 0.17. The proposed third ratio results in a spacing between the spark plug and a fuel outlet opening in the combustion chamber which is adapted to the cylinder bore so that a favorable fuel distribution in the combustion chamber is obtained which ensures reliable ignition.

The spark plug is preferably positioned in such a way that a fourth spacing is generated between the exhaust valve axis and the free end section of the spark plug central electrode, wherein a fourth ratio of fourth spacing to bore diameter is provided in a range from 0.02 to 0.13, in particular from 0.04 to 0.1. In this way, a charge movement generated during a charge exchange is adapted to the fuel quantity which is injected into the combustion chamber, so that the fuel is distributed uniformly within the hollow fuel jet. Ignitable mixture proportions are thereby provided in the region of the electrodes of the spark plug at the time of ignition.

Preferably, the spark plug is positioned in such a way that a fifth spacing is generated between the intake valve axis and the free end section of the spark plug central electrode at a fifth ratio of spacing to bore diameter is in a range between 0.25 and 0.4, preferably between 0.3 and 0.35. This ensures that the fuel particles are guided along the hollow cone in the direction of the spark plug in a controlled manner which is adapted to the combustion chamber configuration. Furthermore, a satisfactory contact surface with the combustion air is provided, as a function of the bore diameter, for the fuel droplets which are swirled at the outer region of the hollow cone.

Further features and feature combinations can be gathered from the description. The invention is illustrated in a simplified fashion in the drawings and will become more readily apparent from the following description on the basis of the accompanying drawings:

### BRIEF DESCRIPTION OF THE DRAWINGS

FIG. 1 is a schematic sectioned illustration of a cylinder of a direct-injection, spark-ignition internal combustion engine, and

FIG. 2 is an enlarged sectioned schematic illustration of a combustion chamber of the internal combustion engine according to FIG. 1.

### DESCRIPTION OF PARTICULAR EMBODIMENTS

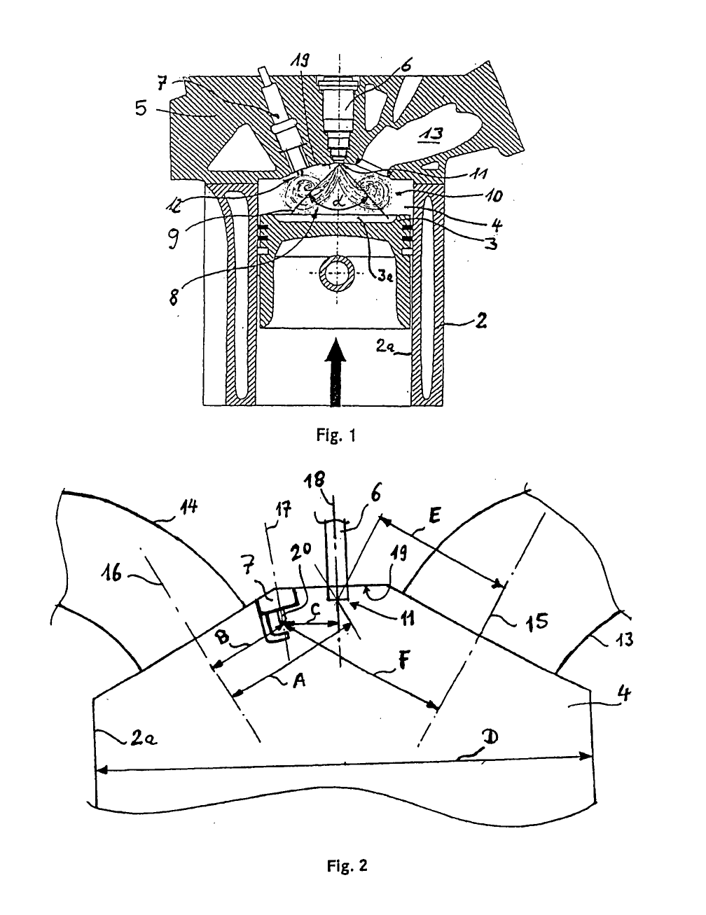

FIG. 1 shows a cylinder 2 of a spark-ignition internal combustion engine 1 with direct injection, in which a combustion chamber 4 is delimited between a piston 3 and a cylinder head 5. The internal combustion engine 1 comprises, per combustion chamber 4, at least one intake valve, at least one exhaust valve, a fuel injector 6 and a spark plug 7, with the fuel injector 6 and the spark plug 7 being provided adjacent to one another in the central region of a combustion chamber roof 19. The number of intake and exhaust valves can be variably selected within the context of the invention. However, the present exemplary embodiment is particularly suitable for internal combustion engines having in each cylinder two intake and exhaust valves. Intake and exhaust ducts 13, 14 are provided in the cylinder head 5, with a piston depression 3a preferably being provided in the piston 3. Furthermore, the cylinder 2 has a cylinder bore 2 with a bore diameter D.

In order to obtain optimum ignition conditions in the region of the boundary vortex 10 which is present at the electrodes 12 of the spark plug 7 at the time of ignition, it is necessary to adapt the combustion chamber configuration to the jet-controlled combustion method. It is therefore an aim of the invention to provide that, by means of a corresponding combustion chamber configuration, ignitable regions of the boundary vortex 10 formed are, at the time of ignition, in close vicinity to an ignition spark generated by the spark plug 7.

According to the invention, the arrangement of the spark plug 7 and of the fuel injector 6 is configured with regard to the combustion chamber conditions and in particular to the cylinder bore 2a. The fuel injector 6 is positioned, as per FIG. 2, in the central region of the combustion chamber roof 19 and has an outwardly opening injection nozzle, with a fuel outlet end including an end including an opening 11 of the injection nozzle projecting into the combustion chamber 4. The spark plug 7 is likewise arranged in the combustion chamber roof, at the exhaust side between the exhaust duct 16 and the fuel injector 6. However, within the context of the invention, the spark plug can likewise be arranged at the intake side.

The present invention provides that the arrangement of the fuel injector 6 is selected so as to be adapted to the positions of the axes 15, 16 of the intake and exhaust ducts 13, 14 relative to the cylinder bore 2a. By means of the proposed combustion chamber configuration, therefore, a possible formation of fuel-depleted zones in the electrode region at an ignition time is avoided in order to minimize the occurrence of ignition misfires. The combustion chamber 4 of the internal combustion engine 1 according to the invention is designed such that a first ratio E/D of first spacing E to bore diameter D is in a range from 0.15 to 0.22, in particular from 0.17 to 0.19. Here, the first spacing E corresponds to a shortest distance between the fuel outlet opening 11 and a central axis 15 of the intake duct 13. As a result of the proposed first spacing E, the fuel quantity is mixed intensively with the compressed combustion air in the outer region of the boundary vortex 10. The transport of ignitable mixture into the vicinity of an ignition spark at the spark plug 7 is thereby promoted.

In order to ensure the formation of ignitable air/fuel mixture in the region of the electrodes 12, the invention according to a second exemplary embodiment provides a combustion chamber configuration in which a second ratio A/D of second spacing A to bore diameter D is in a range from 0.16 to 0.24, in particular from 0.18 to 0.22. Here, the spacing A corresponds to a shortest distance between the fuel outlet opening 11 and a central axis 16 of the exhaust duct 14.

The fuel injector 6 and the spark plug 7 are arranged in the combustion chamber in such a way that a third ratio C/D of third spacing C to bore diameter D is in a range from 0.1 to 0.19, in particular from 0.13 to 0.17. The third spacing C corresponds to a shortest distance between a fuel injector axis 18 and a free end section of the spark plug central electrode 20. The spark plug 7 can be arranged between the intake duct 13 and the fuel injector 6 or between the exhaust duct and the fuel injector 6 while maintaining the third ratio C/D. The proposed ratios result in a spark-plug/fuel-injector arrangement which is adapted to the cylinder bore and which serves to ensure the formation of ignitable mixture in the vicinity of the electrodes of the spark plug. The occurrence of ignition misfires is hereby avoided. The third ratio C/D provides a favorable trade-off between the fuel distribution in the region of the spark plug 7 in relation to the bore diameter D.

The present invention likewise provides that the arrangement of the spark plug 7 is selected so as to be adapted to the positions of the intake and exhaust ducts relative to the cylinder bore 2a. According to a further embodiment of the invention, a fourth ratio B/D of fourth spacing B to bore diameter D is in a range from 0.02 to 0.13, in particular from 0.04 to 0.1. Here, the fourth spacing B corresponds to a shortest distance between a free end section of the central electrode of the spark plug 7 and a central axis 16 of the exhaust duct 14.

The invention also provides that a fifth ratio F/D of fifth spacing F to bore diameter D is in a range from 0.25 to 0.4, in particular from 0.3 to 0.35. Here, the fifth spacing F corresponds to a shortest distance between a free end section of the central electrode of the spark plug 7 and a central axis 15 of the intake duct 13. The provided ratio serves to promote the transport of the ignitable mixture proportions in the outer region of the boundary vortex 10 in the direction of the spark plug 7 in coordination with a charge movement which is formed in the combustion chamber 4. The internal combustion engine 1 illustrated in FIG. 1 operates on the four-stroke principle, wherein according to the invention the internal combustion engine can likewise be embodied as a spark-ignition two-stroke internal combustion engine with direct fuel injection. In the first stroke, the combustion chamber 4 is supplied with combustion air through the intake duct 13, with the piston 3 moving downward to bottom dead center. In the subsequent compression stroke, the piston 3 moves upward from bottom dead center to top dead center, with the fuel being injected during the compression stroke in a stratified-charge mode of the internal combustion engine 1. In the region of top dead center, an air/fuel mixture which is formed is ignited by means of the spark plug 7, with the piston 3 expanding in a downward movement to bottom dead center. In the final stroke, the piston 3 travels in an upward movement to top dead center and pushes the exhaust gases out of the combustion chamber 4.

According to the invention, the internal combustion engine 1 is operated in the stratified-charge mode in the lower and intermediate speed and load ranges, and in the homogeneous mode in the upper load range. The invention is particularly suitable for internal combustion engines having a displacement volume of between two and seven liters, preferably between three and six liters. Furthermore, cylinder bore diameters of between 85 mm and 100 mm are preferable.

A jet-controlled combustion method is provided in particular in the stratified-charge mode. The injection of the fuel is carried out with a fuel injection pressure of approximately 60 to 500 bar. In stratified-charge mode in particular, the fuel injection is carried out with a fuel injection pressure of approximately 180 to 220 bar, preferably 195 to 205 bar, at a time at which a counterpressure in the combustion chamber at the time of the fuel injection is between eight and twenty bar, preferably between ten and sixteen bar. This corresponds, in the present exemplary embodiment, to a crank angle range between 50° and 10° before ignition top dead center. The crank angle range specified here serves merely as an example; depending on the design and mode of operation of the internal combustion engine, and depending on the load point, the counterpressure range or cylinder pressure range proposed according to the invention can be situated in another crank angle range. The proposed combustion chamber counterpressure is for example necessarily situated in an earlier crank angle range in charged internal combustion engines than in non-charged internal combustion engine.

In the jet-controlled combustion method proposed according to the invention, use is preferably made of an outwardly-opening injection nozzle 11 by means of which a hollow fuel cone 8 is generated with an angle α of between 75° and 100°, preferably between 85° and 95° or between 80° and 90°. Since the hollow fuel cone 8 impinges on combustion air which is compressed in the combustion chamber 4, a toroidal boundary vortex 10 is formed in the combustion chamber 4 in such a way that an ignitable air/fuel mixture is obtained in the region of the electrodes 12 of the spark plug 7. The arrangement of the spark plug 7 is selected such that the electrodes 12 of the spark plug 7 project into the boundary vortex 10 which is obtained, with said electrodes 12 being situated outside an envelope 9 of the fuel cone 8 during the fuel injection. As a result, the electrodes 12 of the spark plug 7 are scarcely wetted by fuel. By means of the stated ratios, optimum combustion is permitted in particular in the stratified-charge mode, and reliable ignition is obtained at all load points of the internal combustion engine 1.

What is claimed is:

1. An internal combustion engine (1) comprising:
at least one cylinder (2) which has a cylinder bore (2a) in which a combustion chamber (4) is delimited between a piston (3) and a cylinder head (5),
at least one intake duct (13) and at least one exhaust duct (14) formed in the cylinder head (5),
a fuel injector (6) arranged in the cylinder head (5) and having an outwardly opening injection nozzle through which fuel is injected in the form of a hollow cone (8) into the combustion chamber (4), and
a spark plug (7) arranged in the combustion chamber (4) in such a way that, during the fuel injection, the electrodes (12) of the spark plug (7) are situated outside the injected hollow fuel cone,
the fuel injector (6) being positioned in the cylinder head (5) in such a way that a first spacing (E) is provided between a fuel injector outlet opening (11) and an intake duct axis (15), and
the cylinder bore (2a) having a diameter (D) sized so that
a first ratio (E/D) of the first spacing (E) to cylinder bore diameter (D) is provided in a range from 0.15 to 0.22.

2. An internal combustion engine according to claim 1, wherein the ratio E/D is from 0.17 to 0.19.

3. The internal combustion engine as claimed in claim 1, wherein
the spark plug (7) and the fuel injector (6) are positioned at such a distance that a third spacing (C) is generated between an injector axis (18) and a free end section of the spark plug central electrode (20), resulting in
a third ratio (C/D) of the third spacing (C) to the cylinder bore diameter (D) in a range from 0.1 to 0.19.

4. The internal combustion engine as claimed in claim 3, wherein the ratio C/D is from 0.13 to 0.17.

5. The internal combustion engine as claimed in claim 1, wherein
the spark plug (7) is positioned in such a way that a fourth spacing (B) is generated between the exhaust valve axis (16) and the free end section of the spark plug central electrode (7), providing for
a fourth ratio (B/D) of a fourth spacing (B) to bore diameter (D) in a range from 0.02 to 0.13.

6. The internal combustion engine as claimed in claim 5, wherein the fourth ratio B/D is from B/D from 0.04 to 0.1.

7. The internal combustion engine as claimed in claim 1, wherein
the spark plug (7) is positioned in such a way that a fifth spacing (F) is generated between the intake valve axis (15) and the free end section of the spark plug central electrode, providing for
a fifth ratio (F/D) of a fifth spacing (F) to bore diameter (D) in a range between 0.25 and 0.4.

8. The internal combustion engine as claimed in claim 7, wherein the fifth ratio F/O is between 0.3 and 0.35.

9. An internal combustion engine (1) having
at least one cylinder (2) which has a cylinder bore (2a) and in which a combustion chamber (4) is delimited between a piston (3) and a cylinder head (5),
at least one intake duct (13), at least one exhaust duct (14),
a fuel injector (6) which is arranged in the cylinder head (5) and has an outwardly opening injection nozzle through which fuel is injected in the form of a hollow cone (8) into the combustion chamber (4), and
a spark plug (7) which is arranged in the combustion chamber (4) in such a way that, during the fuel injection, the electrodes (12) of the spark plug (7) are situated outside the injected hollow fuel cone, wherein
the fuel injector (6) is positioned in the cylinder head (5) in such a way that a second spacing (A) is generated between the fuel outlet opening (11) and an exhaust valve axis (16), and
the cylinder bore (2a) has a diameter (D),
a second ratio (A/D) of second spacing (A) to bore diameter (D) is provided in a range between 0.16 and 0.24.

10. The internal combustion engine according to claim 9, wherein the second ratio A/D is between 0.18 and 0.22.

11. The internal combustion engine as claimed in claim 9, wherein
the spark plug (7) and the fuel injector (6) are positioned at such a distance that a third spacing (C) is generated between an injector axis (18) and a free end section of the spark plug central electrode (20), providing for
a third ratio (C/D) of the third spacing (C) to the cylinder bore diameter (D) in a range from 0.1 to 0.19.

12. The internal combustion engine as claimed in claim 11, wherein the ratio C/D is from 0.13 to 0.17.

13. The internal combustion engine as claimed in claim 9, wherein
the spark plug (7) is positioned in such a way that a fourth spacing (B) is generated between the exhaust valve axis (16) and the free end section of the spark plug central electrode (7), providing for
a fourth ratio (B/D) of a fourth spacing (B) to bore diameter (D) in a range from 0.02 to 0.13.

14. The internal combustion engine as claimed in claim 13, wherein the fourth ratio B/D is from B/D from 0.04 to 0.1.

15. The internal combustion engine as claimed in claim 9, wherein
the spark plug (7) is positioned in such a way that a fifth spacing (F) is generated between the intake valve axis (15) and the free end section of the spark plug central electrode, providing for
a fifth ratio (F/D) of fifth spacing (F) to bore diameter (D) is in a range between 0.25 and 0.4.

16. The internal combustion engine as claimed in claim 15, wherein the fifth ratio F/O is between 0.3 and 0.35.
